(19) United States
(12) Patent Application Publication
(10) Pub. No.: US 2026/0173018 A1
(43) Pub. Date: Jun. 18, 2026

(54) POSITIONING SYSTEM, RELAY APPARATUS, AND POSITIONING METHOD

(71) Applicant: Sony Interactive Entertainment Inc., Tokyo (JP)

(72) Inventors: Hirotomo Yunoki, Chiba (JP); Kazuhiro Kono, Tokyo (JP)

(73) Assignee: Sony Interactive Entertainment Inc., Tokyo (JP)

(21) Appl. No.: 19/127,587

(22) PCT Filed: Nov. 22, 2022
(86) PCT No.: PCT/JP2022/043214

§ 371 Date: May 6, 2025

(51) Int. Cl. H04W 64/00; G01S 5/02

(52) U.S. Cl. CPC H04W 64/00; G01S 5/0284

(57) ABSTRACT

Positioning accuracy based on inter-apparatus communications is enhanced. A positioning system (1) includes a fixed apparatus (10) disposed in a prescribed position in real space, a positioning target apparatus (20) being carried by a mobile body, and a relay apparatus (30) that is disposed in a prescribed position away from the fixed apparatus (10) and is capable of performing wireless communication with the fixed apparatus (10) and the positioning target apparatus (20). In a case where a relative position of the relay apparatus (30) with respect to the fixed apparatus (10) calculated based on inter-apparatus communications satisfies a prescribed condition, the positioning system (1) estimates a position of the positioning target apparatus (20) in the real space based on a relative position of the positioning target apparatus (20) with respect to the fixed apparatus (10) calculated based on inter-apparatus communications.

### TECHNICAL FIELD

The present disclosure relates to a positioning system, a relay apparatus, and a positioning method.

### BACKGROUND ART

PTL 1 describes a positioning target apparatus which is used to perform operations for an application of a game or the like. The positioning target apparatus is capable of performing wired or wireless communication with an information processing apparatus executing the application, so that a signal corresponding to a user operation performed on the positioning target apparatus is transmitted to the information processing apparatus. In addition, PTL 1 further describes disposing, in the positioning target apparatus, a light output section that outputs light upon receiving light from a light source such as an LED (light-emitting diode), and detecting the light of the light output section through a camera connected with the information processing apparatus, thereby detecting a position of the positioning target apparatus (a position of a user carrying the positioning target apparatus).

### CITATION LIST

### Patent Literature

[PTL 1] Japanese Patent Laid-open No. 2022-107542

### SUMMARY

### Technical Problem

In order to detect the position of a positioning target apparatus or the position of a mobile body such as a user carrying the positioning target apparatus, an apparatus capable of communicating with the positioning target apparatus may be disposed in a prescribed position in real space, and a distance between the two apparatuses may be calculated based on communications between the apparatuses, for example. However, signals being exchanged under communications between the two apparatuses can be reflected by a wall surface, a floor surface, or a ceiling surface of a room and then reach a transmission destination apparatus, or can be affected by influence of noise, for example. This deviates the distance between the two apparatuses and the respective positions of the apparatuses calculated based on communications between the apparatuses, from the actual distance and the actual positions. The deviation becomes a factor of degradation in positioning accuracy based on inter-apparatus communications.

An object of the present disclosure is to enhance the positioning accuracy based on inter-apparatus communications.

### Solution to Problem

A positioning system according to the present disclosure is to estimate a position of a positioning target apparatus being carried by a mobile body. The system calculates, on the basis of wireless communications between a fixed apparatus disposed in a prescribed position in real space and a relay apparatus disposed in a prescribed position away from the fixed apparatus, a relative position of the relay apparatus with respect to the fixed apparatus, calculates a relative position of the positioning target apparatus with respect to the relay apparatus on the basis of wireless communications between the relay apparatus and the positioning target apparatus, calculates a relative position of the positioning target apparatus with respect to the fixed apparatus on the basis of the calculated relative position of the relay apparatus with respect to the fixed apparatus and the calculated relative position of the positioning target apparatus with respect to the relay apparatus, stores the calculated relative position of the relay apparatus with respect to the fixed apparatus, and estimates, in a case where the stored relative position of the relay apparatus with respect to the fixed apparatus satisfies a prescribed condition, a position of the positioning target apparatus in the real space, on the basis of the calculated relative position of the positioning target apparatus with respect to the fixed apparatus. According to this positioning system, the accuracy of positioning the positioning target apparatus based on inter-apparatus communications can be enhanced.

Moreover, a relay apparatus according to the present disclosure is disposed in a prescribed position away from a fixed apparatus disposed in a prescribed position in real space. The relay apparatus calculates, on the basis of wireless communications with a positioning target apparatus being carried by a mobile body, a relative position of the positioning target apparatus with respect to the relay apparatus, and transmits the calculated relative position of the positioning target apparatus with respect to the relay apparatus to the fixed apparatus. According to this relay apparatus, the accuracy of positioning the positioning target apparatus by the fixed apparatus or an apparatus connected therewith can be enhanced.

Furthermore, a positioning method according to the present disclosure includes, at a positioning system to estimate a position of a positioning target apparatus being carried by a mobile body, calculating, on the basis of wireless communications between a fixed apparatus disposed in a prescribed position in real space and a relay apparatus disposed in a prescribed position away from the fixed apparatus, a relative position of the relay apparatus with respect to the fixed apparatus, calculating a relative position of the positioning target apparatus with respect to the relay apparatus on the basis of wireless communications between the relay apparatus and the positioning target apparatus, calculating a relative position of the positioning target apparatus with respect to the fixed apparatus on the basis of the calculated relative position of the relay apparatus with respect to the fixed apparatus and the calculated relative position of the positioning target apparatus with respect to the relay apparatus, storing the calculated relative position of the relay apparatus with respect to the fixed apparatus, and estimating, in a case where the stored relative position of the relay apparatus with respect to the fixed apparatus satisfies a prescribed condition, a position of the positioning target apparatus in the real space, on the basis of the calculated relative position of the positioning target apparatus with respect to the fixed apparatus. According to this positioning method, the accuracy of positioning the positioning target apparatus based on inter-apparatus communications can be enhanced.

### BRIEF DESCRIPTION OF DRAWINGS

FIG. 1 is a diagram depicting a positioning system which is one example of an embodiment of the present disclosure.

FIG. 2 is a diagram depicting one example of a hardware configuration of each of apparatuses.

FIG. 3 is a functional block diagram depicting one example of functions that are implemented in the positioning system.

FIG. 4 is a diagram depicting one example of a method of calculating a distance between apparatuses.

FIG. 5A is a diagram depicting one example of a method of calculating a distance and an angle between apparatuses.

FIG. 5B is a diagram depicting one example of a method of calculating a distance and an angle between apparatuses.

FIG. 6 is a diagram depicting one example of a method of calculating a relative position of a positioning target apparatus.

FIG. 7 is a diagram depicting one example of a positioning process flow that is executed in the positioning system.

### DESCRIPTION OF EMBODIMENT

### [1. System Configuration]

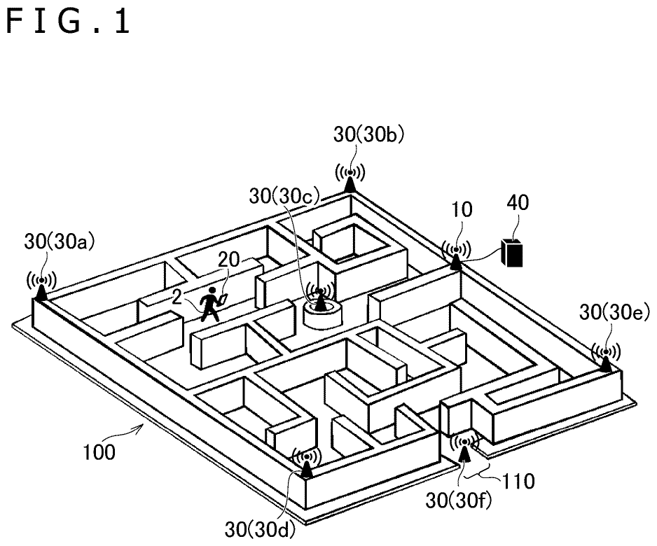

Hereinafter, an embodiment of the present disclosure will explained with reference to the drawings. FIG. 1 is a diagram depicting a positioning system 1 which is one example of an embodiment of the present disclosure. As depicted in FIG. 1, the positioning system 1 includes a fixed apparatus 10 disposed in a prescribed position in real space, and a positioning target apparatus 20 being carried by a user 2 as a mobile body. The positioning system 1 may include an information processing 40 that is capable of performing wired or wireless communication with the fixed apparatus. The information processing apparatus 40 may execute an application of a game or the like. The information processing apparatus 40 may be electrically connected to a display device such as a liquid crystal display or an organic EL (Electro Luminescence) display to display the execution status 41 the application. In this case, the positioning system 1 may include the display device electrically connected with the information processing apparatus 40.

The positioning target apparatus 20 is carried by, for example, the user 2. The positioning target apparatus 20 includes an antenna (described later) so as to become capable of wirelessly communicating with the fixed apparatus 10 and a relay apparatus 30 (described later). The positioning target apparatus 20 may include an inertial measurement unit (IMU) for detecting an acceleration, a velocity, an attitude (tilt) of the positioning target apparatus 20, and the like.

In addition, the positioning system 1 includes the relay apparatus 30 disposed in a prescribed position away from the fixed apparatus 10, as depicted in FIG. 1. In the present embodiment, the positioning System 1 includes a plurality of the relay apparatuses 30 (30a to 30f). In the example depicted in FIG. 1, the user 2 is in a maze 100, and a plurality of the relay apparatuses 30a to 30f are fixed in respective positions in the maze 100. By way of example, the fixed apparatus 10 and the plurality of relay apparatuses 30 are set in any positions in the maze 100 by an operation manager who manages a facility such as the maze 100, so that the apparatuses are fixed in prescribed positions in the maze 100. Each of the relay apparatuses 30 includes an antenna (described later) so as to become capable of wirelessly communicating with the fixed apparatus 10 and the positioning target apparatus 20. It is to be noted that the fixed apparatus 10 may also be capable of wirelessly communicating with the positioning target apparatus 20. In addition, six relay apparatuses 30 are disposed in real space in the example depicted in FIG. 1, but the number of the relay apparatuses 30 included in the positioning system 1 may be one or may be a plural number other than 6.

The positioning system 1 (the information processing 40 in the present embodiment) estimates a position of the positioning target apparatus 20, on the basis of communications between the fixed apparatus 10 and the relay apparatus 30 and communications between the relay apparatus 30 and the positioning target apparatus 20, which will be described later. In this estimation, a signal being exchanged in inter-apparatus communications may be reflected by a wall surface, a floor surface, or a ceiling surface of a room or the maze 100 and then reach a transmission destination apparatus, or may be affected by noise or the like. This deviates a distance between two apparatuses and the positions of the apparatuses calculated based on inter-apparatus communications, from the actual distance and the actual positions. With regard to this, in the positioning system 1, in a case where the position of the relay apparatus 30 calculated based on communications between the fixed apparatus 10 and the relay apparatus 30 satisfies a prescribed condition, a position of the positioning target apparatus 20 calculated based on communications between apparatuses is estimated as the position of the positioning target apparatus 20 in real space. Accordingly, generation of a deviation between the position of the positioning target apparatus 20 estimated by the positioning system 1 and the actual position of the positioning target apparatus 20 is prevented, and the positioning accuracy based on inter-apparatus communications is enhanced.

### [2. Hardware Configuration]

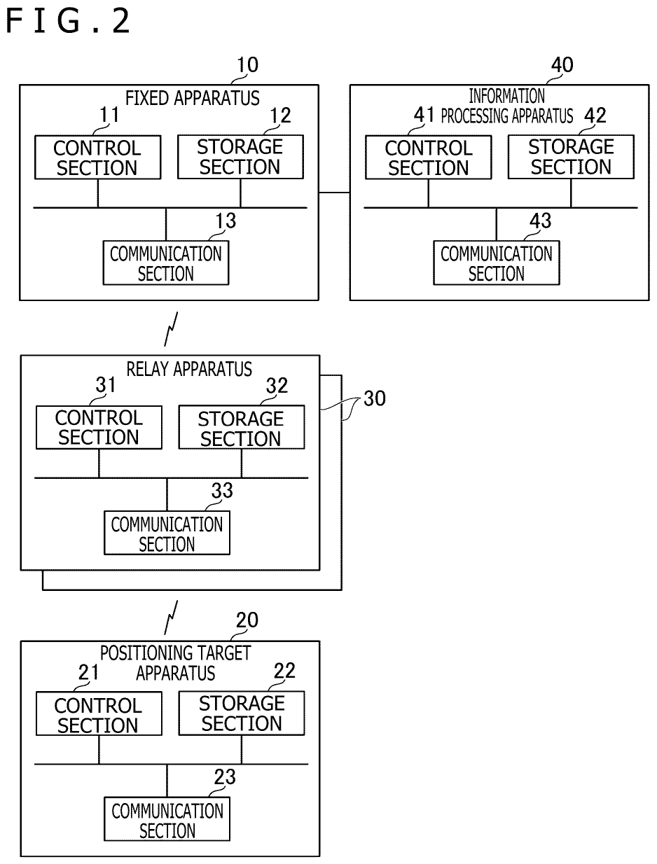

FIG. 2 is a diagram depicting one example of a hardware configuration of apparatuses included in the positioning system 1. The fixed apparatus 10 may be a small computer such as a microcomputer. Further, the fixed apparatus 10 may be a computer such as a game apparatus, a video replay apparatus, a personal computer, or a server apparatus, for example. The fixed apparatus 10 includes a control section 11, a storage section 12, and a communication section 13, for example, as depicted in FIG. 2.

In the fixed apparatus 10, the control section 11 is a program control processor (control device) such as a CPU (central processing unit) that works in accordance with a program such as firmware stored in the storage section 12. The storage section 12 is a storage element such as a ROM (read only memory) or RAM (random access memory), or is an auxiliary storage such as an SSD (solid state drive) or an HDD (hard disk drive). The communication section 13 is a communication device such as a network board, for example.

The information processing apparatus 40 includes a control section 41 which is a processor, a storage section 42 which is a storage such as a memory, and a communication section 43 which is a communication device, for example. The information processing apparatus 40 may further include a display control section that transmits video signals to the display device to display various types of images on the display device. In addition, the information processing apparatus 40 may include an optical disk drive which reads out an optical disk, a video output terminal such as an HDMI (high definition multimedia interface) (registered trademark), a data input/output terminal such as a USB (universal serial bus), and a sound input/output terminal such as a microphone, a speaker, or an earphone jack.

The positioning target apparatus 20 may be a small computer such as a microcomputer. The positioning target apparatus 20 may be a portable terminal such as a smartphone, or a head mounted display to be mounted on the head of the user 2, for example. Alternatively, the positioning target apparatus 20 may be an ornament such as a ring, a necklace, or a bracelet. In a case where the mobile body is not the user 2 or a person but is a robot, the positioning target apparatus 20 may be mounted on the robot, or may be the robot itself. Like the fixed apparatus 10, the positioning target apparatus 20 includes a control section 21 which is a processor, a storage section 22 which is a storage, and a communication section 23 which is a communication device, as depicted in FIG. 2. By way of example, the control section 21 of the positioning target apparatus 20 works in accordance with a program (e.g. firmware) stored in the storage section 22. The positioning target apparatus 20 may include an operation section that, according to a user operation performed on an operation member such as a button or a touch panel, outputs the operation to the control section 21. In addition, the positioning target apparatus 20 may include a sensor such as an IMU.

The relay apparatus 30 is disposed in a prescribed position away from the fixed apparatus 10. Like the fixed apparatus 10, the relay apparatus 30 may be a small computer such as a microcomputer. The relay apparatus 30 includes a control section 31 which is a processor, a storage section 32 which is a storage, and a communication section 33 which is a communication device, as depicted in FIG. 2. By way of example, the control section 31 of the relay apparatus 30 works in accordance with a program (e.g. firmware) stored in the storage section 32. The communication section 33 of the relay apparatus 30 includes an antenna (described later) to become capable of wirelessly communicating with the communication section 33 of the fixed apparatus 10.

### [3. Functional Blocks]

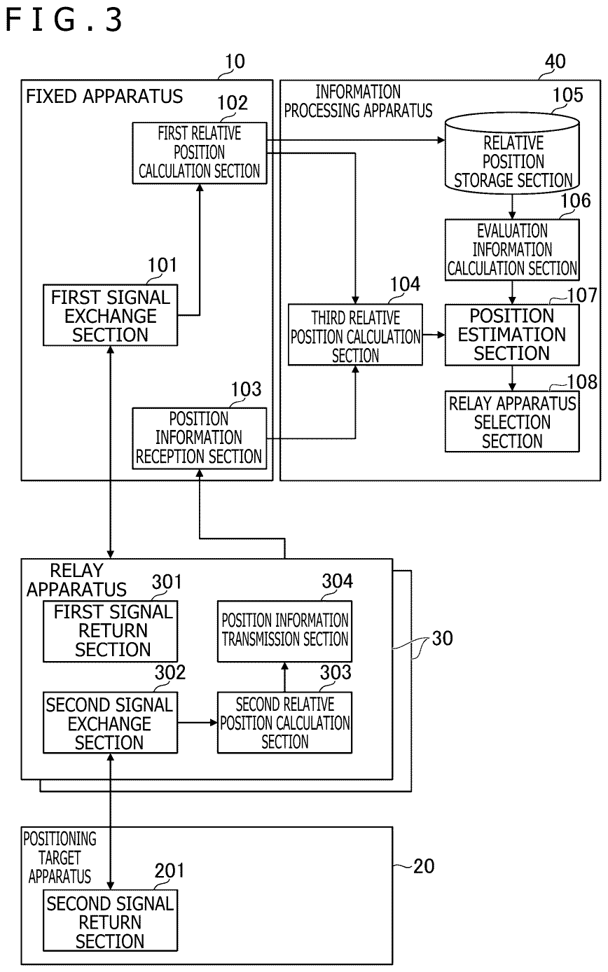

FIG. 3 is a functional block diagram depicting one example of functions that are implemented in the positioning system 1. The fixed apparatus 10 of the example depicted in FIG. 3 functionally includes a first signal exchange section 101, a first relative position calculation section 102, and a position information reception section 103. These functions may be implemented mainly by the control section 11 of the fixed apparatus 10.

Also, the information processing apparatus 40 of the example depicted in FIG. 3 functionally includes a third relative position calculation section 104, a relative position storage section 105, an evaluation information calculation section 106, a position estimation section 107, and a relay apparatus selection section 108. The third relative position calculation section 104, the evaluation information calculation section 106, the position estimation section 107, and the relay apparatus selection section 108 may be implemented mainly by the control section 41 of the information processing apparatus 40. The relative position storage section 105 may be implemented mainly by the storage section 42 of the information processing apparatus 40. It is to be noted that, in a case where the fixed apparatus 10 is a computer such as a game apparatus, a personal computer, or a server apparatus, the third relative position calculation section 104, the evaluation information calculation section 106, the position estimation section 107, and the relay apparatus selection section 108 may be implemented mainly by the control section 11 of the fixed apparatus 10, and the relative position storage section 105 may be implemented mainly by the storage section 12 of the fixed apparatus 10. In this case, the positioning system 1 does not need to include the information processing apparatus 40.

Further, the relay apparatus 30 of the example depicted in FIG. 3 functionally includes a first signal return section 301, a second signal exchange section 302, a second relative position calculation section 303, and a position information transmission section 304. These functions may be implemented mainly by the control section 31 of the relay apparatus 30. Also, the positioning target apparatus 20 of the example depicted in FIG. 3 functionally includes a second signal return section 201. This function may be implemented mainly by the control section 21 of the positioning target apparatus 20.

The first signal exchange section 101 of the fixed apparatus 10 transmits a first signal (request) to the relay apparatus 30 (more specifically, the relay apparatus 30 selected by the relay apparatus selection section 108 which will be described later) through an antenna of the communication section 13. When receiving the first signal transmitted from the fixed apparatus 10, the first signal return section 301 of the relay apparatus 30 transmits (returns) a second signal (response) to the fixed apparatus 10 through an antenna of the communication section 33. The first signal exchange section 101 of the fixed apparatus 10 receives the second signal transmitted from the relay apparatus 30 through an antenna of the communication section 13.

The first relative position calculation section 102 of the fixed apparatus 10 calculates a relative position of the relay apparatus 30 with respect to the fixed apparatus 10, on the basis of communications between the fixe apparatus 10 (more specifically, the first signal exchange section 101) and the relay apparatus 30 (the first signal return section 301). An explanation will be given below of a method of calculating a relative position of the relay apparatus 30 with respect to the fixed apparatus 10. By way of example, the first relative position calculation section 102 calculates the distance and the angle (angle between a facing direction of either one of the fixed apparatus 10 and the relay apparatus 30 and a direction from the one apparatus toward the other apparatus) between the fixed apparatus 10 and the relay apparatus 30, and calculates a relative position of the relay apparatus 30 with respect to the fixed apparatus 10, on the basis of the calculated distance and angle.

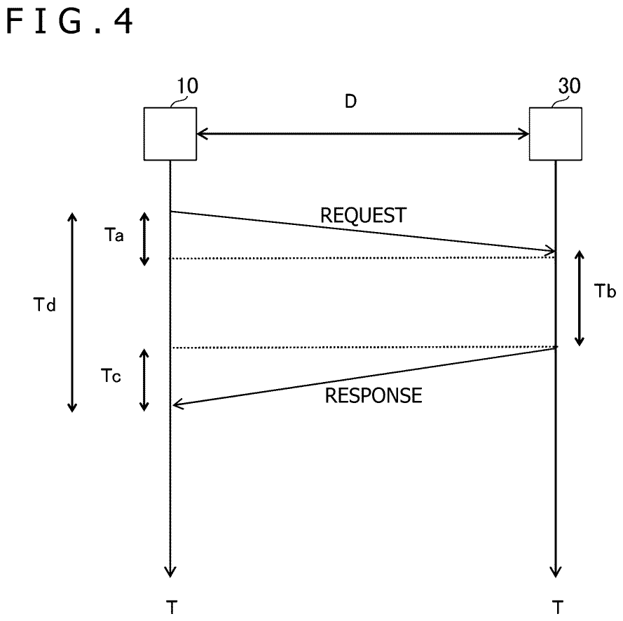

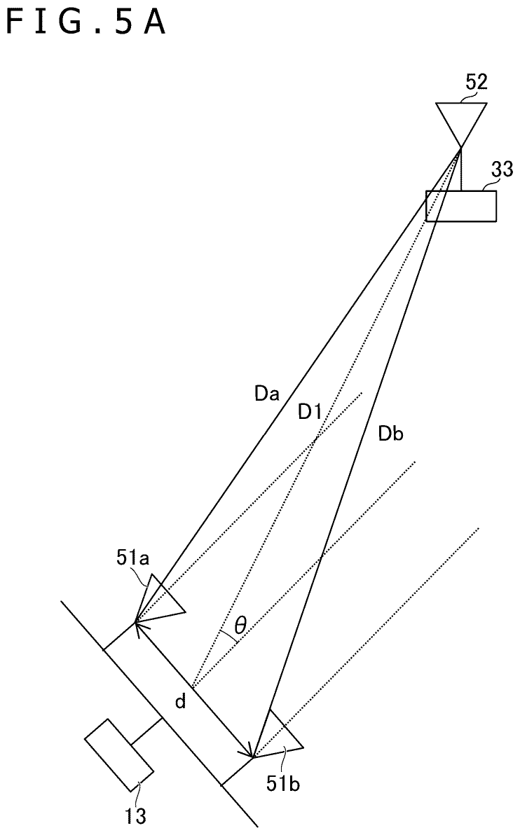

FIG. 4 is a diagram depicting one example of a method of calculating a distance between the fixed apparatus 10 and the relay apparatus 30. FIG. 5A is a diagram depicting one example of a method of calculating the distance and the angle. FIG. 5B is a diagram depicting another example of a method of calculating the distance and the angle.

The first relative position calculation section 102 calculates a distance between the fixed apparatus 10 and the relay apparatus 30, on the basis of a time period required for a signal to go and return between the fixed apparatus 10 and the relay apparatus 30. In the example depicted in FIG. 4, T represents a time lapse. Ta represents a time period from transmission of the first signal (request) from the fixed apparatus 10 (the first signal exchange section 101) to reception of the signal at the relay apparatus 30 (the first signal return section 301). Tb represents a time period from reception of the first signal at the relay apparatus 30 (the first signal return section 301) to transmission (return) of a second signal (response) from the relay apparatus 30. Tc represents a time period from transmission of the second signal from the relay apparatus 30 (the first signal return section 301) to reception of the second signal at the fixed apparatus 10 (the first signal reception section 101). Td represents a time period from transmission of the first signal from the fixed apparatus 10 to reception of the second signal at the fixed apparatus 10 (the first signal exchange section 101), that is, a time period of Ta to Tc.

A distance D1 between the fixed apparatus 10 and the relay apparatus 30 in the example depicted in FIG. 4 can be obtained by an expression: D1=speed of light*(Ta+Tc)/2 or D1=speed of light*(Td−Tb)/2. It is to be noted that “*” represents a multiplication sign.

The first signal return section 301 of the relay apparatus 30 may transmit the second signal (response) with the time period of Tb (a numerical value indicating an amount of seconds or the like) attached, for example. In addition, the first signal return section 301 may transmit the second signal with a reception time of the first signal and a transmission time of the second signal attached, for example. Accordingly, the first relative position calculation section 102 of the fixed apparatus 10 can identify time periods of Ta and Tc or time periods of Td and Tb, on the basis of information regarding the time period or the times attached to the second signal, the transmission time of the first signal, and the reception time of the second signal, and can calculate the distance D1 between the fixed apparatus 10 and the relay apparatus 30. It is to be noted that if the time period of Tb is known, the first signal return sections 301 and 304 may transmit the second signal without information regarding the period or times attached.

The communication section 13 of the fixed apparatus 10 includes a first antenna 51a and a second antenna 51b, in the example depicted in FIG. 5A. Further, the communication section 33 of the relay apparatus 30 includes an antenna 52 that is capable wirelessly communicating with the first antenna 51a and the second antenna 51b. Conversely, the first antenna 51a and the second antenna 51b may be included in the communication section 33 of the relay apparatus 30, and the antenna 52 may be included in the communication section 13 of the fixed apparatus 10. The first antenna 52a and the second antenna 52b face in the same direction (indicated by dotted arrows in FIG. 5A). The first antenna 52a and the second antenna 52b are arranged with a prescribed distance d therebetween in a direction orthogonally intersecting the facing directions of the antennas.

By way of example, when the fixed apparatus 10 is not facing the relay apparatus 30 as depicted in FIG. 5A, or more specifically, when the antenna 52 is displaced from the facing directions of the first antenna 51a and the second antenna 51b, a difference is generated between the distance Da between the first antenna 51a and the antenna 52 and a distance Db between the second antenna 51b and the antenna 52.

Here, the first relative position calculation section 102 may obtain the distance D1 between the fixed apparatus 10 and the relay apparatus 30, on the basis of a first time period T1 required for a signal to go and return between the first antenna 51a and the antenna 52 and a second time period T2 required for a signal to go and return between the second antenna 51b and the antenna 52. By way of example, the first relative position calculation section 102 may calculate the distance Da between first antenna 51a and the antenna 52, on the basis of the first time period T1, calculate the distance Db between the second antenna 51b and the antenna 52, the basis of the second time period T2, and calculate, as the distance D1 between the fixed apparatus 10 and the relay apparatus 30, the mean value of the distances Da and Db.

Alternatively, the first relative position calculation section 102 may calculate an angle (azimuth angle) θ between the facing direction of the fixed apparatus 10 (or the relay apparatus 30) and the direction from the fixed apparatus 10 toward the relay apparatus 30, on the basis of the first time period T1 required for a signal to go and return between the first antenna 51a and the antenna 52 and the second time period T2 required for a signal to go and return between the second antenna 51b and the antenna 52. The angle θ can be obtained by, for example, an expression: θ=arccos((ψλ)/2nd). “ψ” represents a phase difference between signals received at the first antenna 51a and the second antenna 51b. “λ” represents a wavelength of a signal. “π” represents a circular constant. “d” represents the distance between the first antenna 51a and the second antenna 51b (see FIG. 5A). In the example depicted in FIG. 5A, the first relative position calculation section 102 calculates a relative position of the relay apparatus 30 with respect to the fixed apparatus 10, on the basis of the distance D1 and the angle θ calculated in the above-mentioned manner.

The communication section 13 of the fixed apparatus 10 (or the communication section 33 of the relay apparatus 30) may include an array antenna 53, as depicted in FIG. 5B. The array antenna 53 includes a first set of antennas that are arranged at an interval in a vertical direction (Z-axis direction in FIG. 5B) and a second set of antennas that are arranged in a horizontal direction (X-axis direction in FIG. 5B) The first relative position calculation section 102 may acquire, for each antenna included in the array antenna 53, a time period for a signal to go and return between the antenna and the antenna 54 included in the communication section 13 of the fixed apparatus 10 (or the communication section 33 of the relay apparatus 30), and calculate, on the basis of a plurality of the acquired time periods, the distance D1 between the fixed apparatus 10 and the relay apparatus 30, an azimuth angle θ1 between the facing direction of the fixed apparatus 10 (or the relay apparatus 30) and the direction from the fixed apparatus 10 toward the relay apparatus 30, and an elevation angle θ2. In such a way, the array antenna 53 is used to measure a time period for a signal to go from and return to each of the antennas, whereby the elevation angle θ2 can be calculated in addition to the azimuth angle θ1. In the example depicted in FIG. 5B, the first relative position calculation section 102 can calculate a relative position of the relay apparatus 30 with respect to the fixed apparatus 10, on the basis of the distance D1, the azimuth angle θ1, and the elevation angle θ2 calculated in the above-mentioned manner.

The second signal exchange section 302 of the relay apparatus 30 transmits a third signal (request) to the positioning target apparatus 20 through an antenna of the communication section 33. When receiving the third signal transmitted from the relay apparatus 30, the second signal return section 201 of the positioning target apparatus 20 transmits (returns) a fourth signal (response) to the relay apparatus 30 through an antenna of the communication section 23. The second signal exchange section 302 of the relay apparatus 30 receives the fourth signal transmitted from the positioning target apparatus 20 through an antenna of the communication section 13. When the relay apparatus 30 receives the first signal from the fixed apparatus 10, the second signal exchange section 302 of the relay apparatus 30 may transmit the third signal to the positioning target apparatus 20.

The second relative position calculation section 303 of the relay apparatus 30 calculates a relative position of the positioning target apparatus 20 with respect to the relay apparatus 30, on the basis of communications between the relay apparatus 30 (more specifically, the second signal exchange section 302) and the positioning target apparatus 20 (more specifically, the second signal return section 201). The position information transmission section 304 of the relay apparatus 30 transmits information regarding the relative position of the positioning target apparatus 20 with respect to the relay apparatus 30 calculated by the second relative position calculation section 303 to the fixed apparatus 10 via the communication section 33. The position information reception section 103 of the fixed apparatus 10 receives, via the communication section 13, the information regarding the relative position transmitted from the relay apparatus 30.

Like the first relative position calculation section 102, the second relative position calculation section 303 also may calculate the distance and the angle (angle between the facing direction of either one of the relay apparatus 30 and the positioning target apparatus 20 and the direction from the one apparatus toward the other apparatus) between the relay apparatus 30 and the positioning target apparatus 20, and calculate a relative position of the positioning target apparatus 20 with respect to the relay apparatus 30, on the basis of the calculated distance and angle.

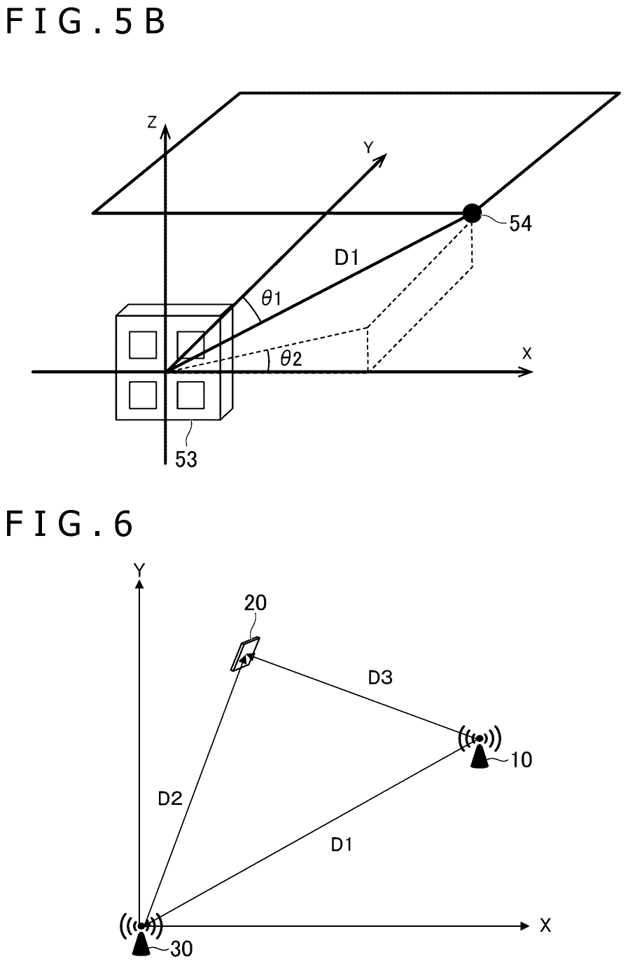

The distance D2 (see FIG. 6) between the relay apparatus 30 and the positioning target apparatus 20 can be calculated based on a time period required for a signal to go and return between the relay apparatus 30 and the positioning target apparatus 20. The distance D2 can be obtained by, for example, an expression: D2=speed of light*(Te+Tf)/2 or D1=speed of light*(Tg−Th)/2. Te represents a time period from transmission of the third signal (request) from the relay apparatus 30 (second signal exchange section 302) to reception of the signal at the positioning target apparatus 20 (second signal return section 201). Tf represents a time period from reception of the third signal at the positioning target apparatus 20 to transmission (return) of the fourth signal (response) from the positioning target apparatus 20 (second signal return section 201). Tg represents a time period from transmission of the fourth signal from the positioning target apparatus 20 (second signal return section 201) to reception of the signal at the relay apparatus 30 (second signal exchange section 302). Th represents a time period from transmission of the third signal from the relay apparatus 30 to reception of the fourth signal at the relay apparatus 30 (second signal exchange section 302), that is, a time period of Te to Th.

In addition, either the communication section 33 the relay apparatus 30 or the communication section 23 of the positioning target apparatus 20 may include a plurality of antennas facing in the same direction. By way of example, either the communication section 33 or the communication section 23 may include the first antenna 51a and the second antenna 51b which are depicted in FIG. 5A, or may include the array antenna 53 which is depicted in FIG. 5B. The plurality of antennas included in either one of the communication section 33 or the communication section 23 communicate with the antenna included in the other section, and distances are calculated, on the basis of times required for signals to go and return under respective communications, for example, so that the distance D2 and the angle between the relay apparatus 30 and the positioning target apparatus 20 can be obtained. Accordingly, the second relative position calculation section 303 can calculate a relative position of the positioning target apparatus 20 with respect to the relay apparatus 30.

The third relative position calculation section 104 of the fixed apparatus 10 or the information processing apparatus 40 calculates a relative position of the positioning target apparatus 20 with respect to the fixed apparatus 10, on the basis of the relative position of the relay apparatus 30 with respect to the fixed apparatus 10 calculated by the first relative position calculation section 102 and the relative position of the positioning target apparatus 20 with respect to relay apparatus 30 calculated by the second relative position calculation section 303. The third relative position calculation section 104 calculates a relative position of the positioning target apparatus 20 with respect to the fixed apparatus 10, on the basis of the relative position of the positioning target apparatus 20 with respect to the relay apparatus 30 transmitted from the position information transmission section 304 of the relay apparatus 30 and received at the position information reception section 103 of the fixed apparatus 10.

In a case where the third relative position calculation section 104 and the relative position storage section 105 (described later) are disposed in the information processing apparatus 40, the fixed apparatus 10 may transmit information regarding the relative position of the relay apparatus 30 with respect to the fixed apparatus 10 calculated by the first relative position calculation section 102 and information regarding the relative position of the positioning target apparatus 20 with respect to the relay apparatus 30 received at the position information reception section 103, to the information processing apparatus 40 through the communication section 13. The information processing apparatus 40 may receive information regarding these relative positions transmitted from the fixed apparatus 10 through the communication section 43.

FIG. 6 is a diagram depicting one example of a method of calculating a relative position of the positioning target apparatus 20 with respect to the fixed apparatus 10. In FIG. 6, the distance between the fixed apparatus 10 and the relay apparatus 30 is D1, the distance between the relay apparatus 30 and the positioning target apparatus 20 is D2, and the distance between the fixed apparatus 10 and the positioning target apparatus 20 is D3.

By way of example, the third relative position calculation section 104 calculates a relative position of the positioning target apparatus 20 with respect to the fixed apparatus 10 by subtracting the relative position of the relay apparatus 30 with respect to the fixed apparatus 10 calculated by the first relative position calculation section 102 from the relative position of the positioning target apparatus 20 with respect to the relay apparatus 30 calculated by the second relative position calculation section 303. As a result, the relative position of the positioning target apparatus 20 with respect to the fixed apparatus 10 is obtained. In addition, in a case where a deviation in relative positions caused by reflection of signals, noise, or the like is generated between the relative position of the positioning target apparatus 20 with respect to the relay apparatus 30 calculated by the second relative position calculation section 303 and the relative position of the relay apparatus 30 with respect to the fixed apparatus 10 calculated by the first relative position calculation section 102, the deviation in relative positions caused by reflection of a signal, noise, or the like can be reduced by subtracting one of the relative positions from the other relative position. Accordingly, the relative position of the positioning target apparatus 20 calculated by the third relative position calculation section 104 can be prevented from being significantly deviated from the actual position of the positioning target apparatus 20.

The relative position storage section 105 of the fixed apparatus 10 or the information processing apparatus 40 stores the relative position of the relay apparatus 30 with respect to the fixed apparatus 10 calculated by the first relative position calculation section 102. The relative position storage section 105 stores a plurality of the relative positions calculated by the first relative position calculation section 102. By way of example, each time the first relative position calculation section 102 calculates a relative position of the relay apparatus 30 with respect to the fixed apparatus 10, the relative position storage section 105 stores the relative position.

Based on a plurality of the relative positions stored in the relative position storage section 105, the evaluation information calculation section 106 of the fixed apparatus 10 or the information processing apparatus 40 calculates evaluation information for determining whether or not the relative position of the relay apparatus 30 calculated, on the basis of communications between the fixed apparatus 10 and the relay apparatus 30 by the first relative position calculation section 102 satisfies a prescribed condition. The evaluation information calculation section 106 calculates the evaluation information, on the basis of a plurality of relative positions of the relay apparatus 30 during a sampling period from a first timing that is the latest calculation timing of a relative position at the first relative position calculation section 102 to a second timing that is earlier than the first timing. By way of example, the evaluation information calculation section 106 calculates a variance of the plurality of relative positions during the sampling period from the first timing that is the latest timing to the second timing that is earlier than the first timing The evaluation information calculation section 106 may calculate a mean value or median of the plurality of relative positions during the sampling period.

In a case where a relative position of the relay apparatus 30 with respect to the fixed apparatus 10 calculated by the first relative position calculation section 102 satisfies the prescribed condition, the position estimation section 107 of the fixed apparatus 10 or the information processing apparatus 40 estimates a position of the positioning target apparatus 20 in real space, on the basis of the relative position of the positioning target apparatus 20 with respect to the fixed apparatus 10 calculated by the third relative position calculation section 104. In a case where the relative position of the relay apparatus 30 with respect to the fixed apparatus 10 calculated by the first relative position calculation section 102 is significantly deviated from the actual position of the relay apparatus 30 due to reflection of a signal, noise, or the like, the similar deviation is possibly generated in the relative position of the positioning target apparatus 20 with respect to the fixed apparatus 10 calculated by the third relative position calculation section 104. For this reason, in a case where the relative position of the relay apparatus 30 calculated by the first relative position calculation section 102 satisfies the prescribed condition, the position of the positioning target apparatus 20 in real space is estimated. Accordingly, the estimated position of the positioning target apparatus 20 can be prevented from being significantly deviated from the actual position of the positioning target apparatus 20.

In a case where the relative position of the relay apparatus 30 calculated by the first relative position calculation section 102 falls under a prescribed range from the actual position of the relay apparatus 30 in real space (e.g. a range within 1 m from the actual position of the relay apparatus 30), the position estimation section 107 may estimate the position of the positioning target apparatus 20 in real space, on the basis of the relative position of the positioning target apparatus 20 calculated by the third relative position calculation section 104. In addition, in a case where the evaluation information (evaluation information calculated, on the basis of the plurality of relative positions during the sampling period from the past second timing to the latest first timing) calculated by the evaluation information calculation section 106 satisfies the prescribed condition, the position estimation section 107 may estimate a position of the positioning target apparatus 20 in real space.

By way of example, in a case where a variance of the relative positions of the relay apparatus 30 calculated as evaluation information by the evaluation information calculation section 106 is equal to or less than a prescribed variance, the position estimation section 107 estimates a position of he positioning target apparatus 20 in real space, on the basis of the relative position of the positioning target apparatus 20 with respect to the fixed apparatus 10 calculated by the third relative position calculation section 104. By way of example, in a case where a variance of the relative positions of the relay apparatus 30 with respect to the fixed apparatus 10 during the sampling period calculated by the evaluation information calculation section 106 is equal to or less than a variance of relative positions of the relay apparatus 30 with respect to the fixed apparatus 10 during a period longer than the sampling period, the position estimation section 107 estimates a position of the positioning target apparatus 20 in real space. In another example, in a case where a mean value or a median of the relative positions of the relay apparatus 30 during the sampling period calculated by the evaluation information calculation section 106 is equal to or less than a mean value or a median of the relay apparatus 30 during a period longer than the sampling period, the position estimation section 107 may estimate a position of the positioning target apparatus 20 in real space. Accordingly, the position of the positioning target apparatus 20 estimated by the position estimation section 107 can be prevented from being significantly deviated from the actual position of the positioning target apparatus 20, and the accuracy of positioning the positioning target apparatus 20, on the basis of inter-apparatus communications can be enhanced.

The relay apparatus selection section 108 of the fixed apparatus 10 or the information processing apparatus 40 selects one relay apparatus 30 from among a plurality of the relay apparatuses 30 (e.g. the relay apparatuses 30a to 30f depicted in FIG. 1), on the basis of the position of the positioning target apparatus 20 in real space estimated by the position estimation section 107. Based on the position of the positioning target apparatus 20 at the first timing that is the latest timing estimated by the position estimation section 107, the relay apparatus selection section 108 selects one relay apparatus 30. Further, the first relative position calculation section 102, the second relative position calculation section 303, and the third relative position calculation section 104 each calculate relative position of the relay apparatus 30 (relay apparatus 30 selected at the first timing by the relay apparatus selection section 108) with respect to the fixed apparatus 10, a relative position of the positioning target apparatus 20 with respect to the relay apparatus 30, and a relative position of the positioning target apparatus 20 with respect to the fixed apparatus 10, at the second timing that is later than the first timing.

By way of example, the relay apparatus selection section 108 selects a relay apparatus 30 disposed at the closest distance from the position of the positioning target apparatus 20 in real space estimated by the position estimation section 107. For example, in a case where the user 2 is around an exit 110 of the maze 100 in the example depicted in FIG. 1, the relay apparatus selection section 108 selects a relay apparatus 30f positioned at the exit 110. In this manner, the distance from the fixed apparatus 10 to the positioning target apparatus 20 via the relay apparatus 30 can be minimized, so that the relative position of the positioning target apparatus 20 calculated by the third relative position calculation section 104 can be prevented from being significantly deviated from the actual relative position of the positioning target apparatus 20.

### [4. Flowchart]

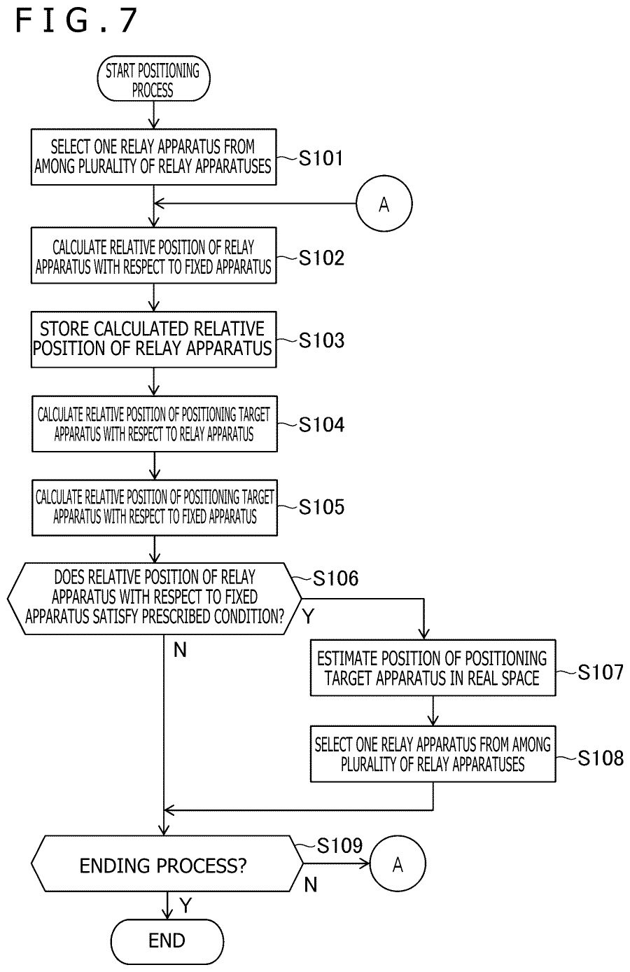

FIG. 7 is a diagram depicting one example of a positioning process flow that is executed in the positioning system 1. First, as depicted in FIG. 7, the relay apparatus selection section 108 of the fixed apparatus 10 or the information processing apparatus 40 selects one relay apparatus 30 from among a plurality of the relay apparatuses 30 (step S101). In step S101, the relay apparatus selection section 108 may select a predetermined relay apparatus 30 (e.g. the relay apparatus 30c disposed in the center portion of the maze 100 in FIG. 1), or may randomly select a relay apparatus 30.

Next, the first relative position calculation section 102 of the fixed apparatus 10 calculates a relative position of the relay apparatus 30 with respect to the fixed apparatus 10, on the basis of communications between the fixed apparatus 10 and the relay apparatus 30 (step S102). In step S102, the first relative position calculation section 102 calculates a relative position of the relay apparatus 30 with respect to the fixed apparatus 10, on the basis of a time period from transmission of the first signal (request) from the first signal exchange section 101 of the fixed apparatus 10 to transmission (return) of the second signal (response) from the first signal return section 301 of the relay apparatus 30.

Next, the control section 11 of the fixed apparatus 10 or the control section 41 of the information processing apparatus 40 causes the relative position storage section 105 to store the relative position of the relay apparatus 30 with respect to the fixed apparatus 10 calculated in step S102 (step S103). In a case where the relative position storage section 105 is disposed in the information processing apparatus 40, the fixed apparatus 10 may transmit information regarding the relative position of the relay apparatus 30 with respect to the fixed apparatus 10 calculated in step S102 to the information processing 40, and the information processing apparatus 40 may receive this information. Accordingly, the information processing apparatus 40 acquires the information regarding the relative position of the relay apparatus 30 calculated in step S102, whereby step S103 can be executed. Since step S103 is executed a plurality of times, a plurality of the relative positions of one relay apparatus 30 are stored in the relative position storage section 105.

Next, the second relative position calculation section 303 of the relay apparatus 30 calculates a relative position of the positioning target apparatus 20 with respect to the relay apparatus 30, on the basis of communications between the relay apparatus 30 and the positioning target apparatus 20 (step S104). In step S104, the second relative position calculation section 303 calculates a relative position of the positioning target apparatus 20 with respect to the relay apparatus 30, on the basis of a time period from transmission of the third signal (request) from the second signal exchange Section 302 of the relay apparatus 30 to transmission of the fourth signal (response) from the second signal return section 201 of the positioning target apparatus 20. By way of example, at a timing at which the relay apparatus 30 receives the first signal transmitted from the fixed apparatus 10, the second signal exchange section 302 may transmit the third signal. Accordingly, the second relative position calculation section 303 can calculate a relative position of the positioning target apparatus 20 with respect to the relay apparatus 30 at the same timing as step S102. It is to be noted that “same timing” means that a time period from one timing to another timing is equal to or shorter than a prescribed time period (e.g. within one second).

Next, the third relative position calculation section 104 of the fixed apparatus 10 or the information processing apparatus 40 calculates a relative position of the positioning target apparatus 20 with respect to the fixed apparatus 10, on the basis of the relative position of the relay apparatus 30 with respect to the fixed apparatus 10 calculated in step S102 and the relative position of the positioning target apparatus 20 with respect to the relay apparatus 30 calculated in step S104 (step S105). In step S105, the third relative position calculation section 104 calculates a relative position of the positioning target apparatus 20 with respect to the fixed apparatus 10 by, for example, subtracting the relative position of the relay apparatus 30 with respect to the fixed apparatus 10 from the relative position of the positioning target apparatus 20 with respect to the relay apparatus 30.

In the present embodiment, prior to execution of step S105 by the third relative position calculation section 104, the position information transmission section 304 of the relay apparatus 30 transmits information regarding the relative position of the positioning target apparatus 20 calculated in step S104, to the fixed apparatus 10. Then, the position information reception section 103 of the fixed apparatus 10 receives the information regarding the relative position transmitted from the relay apparatus 30. Accordingly, the fixed apparatus 10 can acquire the information regarding the relative position of the positioning target apparatus 20 calculated in step S104. In addition, in a case where the third relative position calculation section 104 is disposed in the information processing apparatus 40, the fixed apparatus 10 transmits information regarding the relative position of the positioning target apparatus 20 calculated in step S103 to the information processing 40 and the information processing apparatus 40 receives the information. As a result, the information processing apparatus 40 can execute step S105.

Next, the position estimation section 107 of the fixed apparatus 10 or the information processing apparatus 40 determines whether or not the relative position of the relay apparatus 30 with respect to the fixed apparatus 10 calculated in step S102 satisfies a prescribed condition (step S106). By way of example, in step S106, the position estimation section 107 may determine whether or not the relative position of the relay apparatus 30 calculated by the first relative position calculation section 102 is within a prescribed range from the actual position of the relay apparatus 30 in real space.

In another example, in step S106, the evaluation information calculation section 106 of the fixed apparatus 10 or the information processing apparatus 40 may calculate the evaluation information, on the basis of a plurality of the relative positions stored in the relative position storage section 105 in step S102. In this case, the evaluation information calculation section 106 may calculate the evaluation information based on a plurality of relative positions during the sampling period from the first timing that is the latest calculation timing of the calculation of a relative position by the first relative position calculation section 102 to the second timing that is earlier than the first timing. The evaluation information calculation section 106 may calculate a variance (or a mean value or median) of the plurality of relative positions during the sampling period. In step S106, the position estimation section 107 may determine whether or not the evaluation information calculated by the evaluation information calculation section 106 satisfies a prescribed condition. The position estimation section 107 may determine whether or not variance (or a mean value or median) of the relative positions of the relay apparatus 30 during the sampling period calculated by the evaluation information calculation section 106 is equal to or less than a variance (or a mean value or median) of relative positions of the relay apparatus 30 during a period longer than the sampling period.

It is to be noted that, in a case where the sampling period has not elapsed from the selection of one relay apparatus 30 in step S101, the position estimation section 107 and the relay apparatus selection section 108 can skip step S107 and step S108. Also, in a case where the sampling period has not elapsed from selection in step S108 (described later) of the relay apparatus 30 that is different from the previously selected relay apparatus 30, the position estimation section 107 and the relay apparatus selection section 108 can skip step S107 and step S108.

In a case where the relative position of the relay apparatus 30 with respect to the fixed apparatus 10 calculated in step S102 is determined to satisfy the prescribed condition (Y in step S106), the position estimation section 107 estimates a position of the positioning target apparatus 20 in real space, on the basis of the relative position of the positioning target apparatus 20 with respect to the fixed apparatus 10 calculated in step S105 (step S107). Then, the relay apparatus selection section 108 selects one relay apparatus 30 from among the plurality of relay apparatuses 30, on the basis of the position of the positioning target apparatus 20 estimated in step S107. In a case where the relative position of the relay apparatus 30 calculated in step S102 is determined not to satisfy the prescribed condition (Y in step S106), the position estimation section 107 and the relay apparatus selection section 108 execute neither step S107 nor step S108. Accordingly, a position of the positioning target apparatus 20 estimated based on inter-apparatus communications can be prevented from being significantly deviated from the actual position of the positioning target apparatus 20, and the accuracy of positioning the positioning target apparatus 20 can be enhanced.

In a case where ending the process is determined (Y in step S109), the positioning system 1 terminates the positioning process. Until ending the process is determined in step S109, the positioning system 1 repeats steps S102 to S108. The relay apparatus selection section 108 selects one relay apparatus 30 at the first timing, for example (step S108). Then, the first relative position calculation section 102, the second relative position calculation section 303, and the third relative position calculation section 104 each calculate a relative position of the relay apparatus 30 (the relay apparatus 30 selected at the first timing by the relay apparatus selection section 108) with respect to the fixed apparatus 10, a relative position of the positioning target apparatus 20 with respect to the relay apparatus 30, and a relative position of the positioning target apparatus 20 with respect to the fixed apparatus 10, at the second timing that is later than the first timing (steps S102, S104, and S105). Accordingly, it is possible to track the position of the positioning target apparatus 20 (e.g. the position of the user 2 carrying the positioning target apparatus 20) which moves in real space with a lapse of time.

### 5. CONCLUSION

(1) As explained so far, the positioning system 1 having been explained in the present disclosure estimates a position of the positioning target apparatus 20 being carried by a mobile body. The positioning system 1 (the first relative position calculation section 102) calculates, on the basis of wireless communications between the fixed apparatus 10 disposed in a prescribed position in real space and the relay apparatus 30 disposed in a prescribed position away from the fixed apparatus 10, a relative position of the relay apparatus 30 with respect to the fixed apparatus 10. The positioning system 1 (the second relative position calculation section 303) calculates a relative position of the positioning target apparatus 20 with respect to the relay apparatus 30, on the basis of wireless communications between the relay apparatus 30 and the positioning target apparatus 20. The positioning system 1 (the third relative position calculation section 104) calculates a relative position of the positioning target apparatus 20 with respect to the fixed apparatus 10, on the basis of the calculated relative position of the relay apparatus 30 with respect to the fixed apparatus 10 and the calculated relative position of the positioning target apparatus 20 with respect to the relay apparatus 30. The positioning system 1 (the relative position storage section 105) stores the calculated relative position of the relay apparatus 30 with respect to the fixed apparatus 10. In a case where the stored relative position of the relay apparatus 30 with respect to the fixed apparatus 10 satisfies a prescribed condition, the positioning system 1 (the position estimation section 107) estimates a position of the positioning target apparatus 20 in real space, on the basis of the calculated relative position of the positioning target apparatus 20 with respect to the fixed apparatus 10. Accordingly, the position of the positioning target apparatus 20 estimated based on inter-apparatus communications can be prevented from being significantly deviated from the actual position of the positioning target apparatus 20, and the accuracy of positioning the positioning target apparatus 20 can be enhanced.
(9) In addition, the relay apparatus 30 having been explained in the present disclosure is disposed in a prescribed position away from the fixed apparatus 10 disposed in a prescribed position in real space. The relay apparatus 30 (second relative position calculation section 303) calculates, on the basis of wireless communications with the positioning target apparatus 20 being carried by the mobile body, a relative position of the positioning target apparatus 20 with respect to the relay apparatus 30. The relay apparatus 30 (the position information transmission section 304) transmits the calculated relative position of the positioning target apparatus 20 with respect to the relay apparatus 30 to the fixed apparatus 10. Accordingly, the accuracy of positioning the positioning target apparatus 20 by the fixed apparatus 10 or an apparatus connected therewith can be enhanced.
(10) In addition, in the positioning method having been explained in the present disclosure, the positioning system 1 that estimates a position of a positioning target apparatus 20 being carried by a mobile body calculates, on the basis of wireless communications between the fixed apparatus 10 disposed in a prescribed position in real space and the relay apparatus 30 disposed in a prescribed position away from the fixed apparatus 10, a relative position of the relay apparatus 30 with respect to the fixed apparatus 10, and calculates a relative position of the positioning target apparatus 20 with respect to the relay apparatus 30, on the basis of wireless communications between the relay apparatus 30 and the positioning target apparatus 20. Further, a relative position of the positioning target apparatus 20 with respect to the fixed apparatus 10 is calculated, on the basis of the calculated relative position of the relay apparatus 30 with respect to the fixed apparatus 10 and the calculated relative position of the positioning target apparatus 20 with respect to the relay apparatus 30, the calculated relative position of the relay apparatus 30 with respect to the fixed apparatus 10 is stored, and, in a case where the stored relative position of the relay apparatus 30 with respect to the fixed apparatus 10 satisfies a prescribed condition, a position of the positioning target apparatus 20 in real space is estimated based on the calculated relative position of the positioning target apparatus 20 with respect to the fixed apparatus 10. Accordingly, the position of the positioning target apparatus 20 estimated based on inter-apparatus communications can be prevented from being significantly deviated from the actual position of the positioning target apparatus 20, and the accuracy of positioning the positioning target apparatus 20 can be enhanced.
(2) In the positioning system 1 according to (1) above, the positioning system 1 (the third relative position calculation section 104) may calculate the relative position of the positioning target apparatus 20 with respect to the fixed apparatus 10 by subtracting the calculated relative position of the relay apparatus 30 with respect to the fixed apparatus 10 from the calculated relative position of the positioning target apparatus 20 with respect to the relay apparatus 30. Accordingly, in a case where a deviation in relative positions caused by reflection of a signal or noise is generated between the relative position of the positioning target apparatus 20 with respect to the relay apparatus 30 calculated by the second relative position calculation section 303 and the relative position of the relay apparatus 30 with respect to the fixed apparatus 10 calculated by the first relative position calculation section 102, one of the relative positions is subtracted from the other relative position, So that the deviation in relative positions caused by reflection of a signal or noise can be reduced.
(3) In the positioning system 1 according to (1) or (2) above, the positioning system 1 (the evaluation information calculation section 106) may calculate a variance of the stored relative positions of the relay apparatus 30 with respect to the fixed apparatus 10. In a case where the calculated variance is equal to or less than a prescribed variance, the positioning system 1 (the position estimation section 107) may estimate the position of the positioning target apparatus 20 in real space based on the calculated relative position of the positioning target apparatus 20 with respect to the fixed apparatus 10.
(4) In the positioning system 1 according to (3) above, the positioning system 1 (the first relative position calculation section 102) may calculate the relative position of the relay apparatus 30 with respect to the fixed apparatus 10 at a first timing, on the basis of wireless communications between the fixed apparatus 10 and the relay apparatus 30 at the first timing. The positioning system 1 (the second relative position calculation section 303) may calculate the relative position of the positioning target apparatus 20 with respect to the relay apparatus 30 at the first timing, on the basis of wireless communications between the relay apparatus 30 and the positioning target apparatus 20 at the first timing. The positioning system 1 (the third relative position calculation section 104) may calculate the relative position of the positioning target apparatus 20 with respect to the fixed apparatus 10 at the first timing, on the basis of the calculated relative position of the relay apparatus 30 with respect to the fixed apparatus 10 at the first timing and the calculated relative position of the positioning target apparatus 20 with respect to the relay apparatus 30 at the first timing. The positioning system 1 (the relative position storage section 105) may store information regarding the calculated relative position of the relay apparatus 30 with respect to the fixed apparatus 10 at the first timing. The positioning system 1 (the evaluation information calculation section 106) may calculate a variance of the relative positions of the relay apparatus 30 with respect to the fixed apparatus 10 stored in a sampling period from the first timing to a second timing that is earlier than the first timing. In a case where the calculated variance is equal to or less than a variance of the relative positions of the relay apparatus 30 with respect to the fixed apparatus 10 during a period longer than the sampling period, the fixed apparatus 10 (the position estimation section 107) may estimate a position of the positioning target apparatus 20 in real space, on the basis of the calculated relative position of the positioning target apparatus 20 with respect to the fixed apparatus 10 at the first timing.
(5) (6) (7) The positioning system 1 according to any one of (1) to (4) above may include at least one of the fixed apparatus 10, the positioning target apparatus 20, and the relay apparatus 30.
(8) The positioning system 1 according to any one of (1) to (4) above may include a plurality of the relay apparatuses 30 that are disposed in prescribed positions away from the fixed apparatus 10. The positioning system 1 (the relay apparatus selection section 108) may select one relay apparatus 30 from among a plurality of the relay apparatuses 30, on the basis O the estimated position of the positioning target apparatus 20 in real space at a first timing. The positioning system 1 (the first relative position calculation section 102) may calculate a relative position of the selected one relay apparatus 30 with respect to the fixed apparatus 10 at a second timing that is later than the first timing, on the basis of wireless communications between the fixed apparatus 10 and the one relay apparatus 30. The positioning system 1 (the second relative position calculation section 303) may calculate the relative position of the positioning target apparatus 20 with respect to the selected one relay apparatus 30 at the second timing, on the basis of wireless communications between the one relay apparatus 30 and the positioning target apparatus 20. The positioning system 1 (the third relative position calculation section 104) may calculate a relative position of the positioning target apparatus 20 with respect to the fixed apparatus 10 at the second timing, on the basis of the calculated relative position of the one relay apparatus 30 at the second timing and the calculated relative position of the positioning target apparatus 20 with respect to the one relay apparatus 30 at the second timing. The positioning system 1 (the relative position storage section 105) may store information regarding the calculated relative position of the relay apparatus 30 with respect to the fixed apparatus 10 at the second timing. In a case where the stored relative position of the one relay apparatuses 30 with respect to the fixed apparatus 10 satisfies a prescribed condition, the positioning system 1 (the position estimation section 107) may estimate a position of the positioning target apparatus 20 in real space based on the calculated relative position of the positioning target apparatus 20 with respect to the fixed apparatus 10 at the second timing.

The present disclosure is not limited to the foregoing embodiments. For example, a modification of the foregoing embodiments is also within the technical scope of the present disclosure.

The embodiment in which the fixed apparatus 10 includes the first relative position calculation section 102, the fixed apparatus 10 or the information processing apparatus 40 includes the third relative position calculation section 104, the relative position storage section 105, the evaluation information calculation section 106, and the position estimation section 107, and the relay apparatus 30 includes the second relative position calculation section 303 has been explained. These functions may be included in any one of the fixed apparatus 10, the relay apparatus 30, and the information processing apparatus 40, or may be included in the positioning target apparatus 20. By way of example, the relay apparatus 30 may include the functions of the first relative position calculation section 102 and the third relative position calculation section 104, and the fixed apparatus 10 may include the second relative position calculation section 303. By way of example, information regarding a time required for a signal to go and return between two apparatuses under communications is transmitted to any one of the fixed apparatus 10, the positioning target apparatus 20, the relay apparatus 30, and the information processing apparatus 40, so that an apparatus having received the information can calculate a relative position of one of two apparatuses with respect to the other apparatuses on the basis of the time required for a signal to go and return between the two apparatuses under communications. also, information regarding the relative position of the relay apparatus 30 with respect to the fixed apparatus 10 and the relative position of the positioning target apparatus 20 with respect to the relay apparatus 30 is transmitted to any one of the fixed apparatus 10, the positioning target apparatus 20, the relay apparatus 30, and the information processing apparatus 40, that an apparatus having received the information can calculate a relative position of the positioning target apparatus 20 with respect to the fixed apparatus 10, on the basis of the two relative positions.

In addition, the embodiment in which the fixed apparatus 10 includes the first signal exchange section 101, the relay apparatus 30 includes the first signal return section 301 and the second signal exchange section 302, and the positioning target apparatus 20 includes the second signal return section 201 has been explained. This is a non-limiting embodiment. By way of example, the relay apparatus 30 may include the first signal exchange section 101 and the fixed apparatus 10 may include the first signal return section 301. Further, the positioning target apparatus 20 may include the second signal exchange section 302 and the relay apparatus 30 may include the second signal return section 201. Also with this configuration, a relative position of one of two apparatuses with respect to the other apparatus can be calculated based on a time required for a signal to go and return between the two apparatuses under communications. Further, based on the relative position of the relay apparatus 30 with respect to the fixed apparatus 10 and the relative position of the positioning target apparatus 20 with respect to the relay apparatus 30, a relative position of the positioning target apparatus 20 with respect to the fixed apparatus 10 can be calculated. Accordingly, the position of the positioning target apparatus 20 in real space can be estimated.

1. A positioning system configured to; estimate a position of a positioning target apparatus capable of being carried by a mobile body, wherein
the positioning system
calculates, on a basis of wireless communications between a fixed apparatus disposed in a prescribed position in real space and a relay apparatus disposed in a prescribed position away from the fixed apparatus, a relative position of the relay apparatus with respect to the fixed apparatus,
calculates a relative position of the positioning target apparatus with respect to the relay apparatus on a basis of wireless communications between the relay apparatus and the positioning target apparatus,
calculates a relative position of the positioning target apparatus with respect to the fixed apparatus on a basis of the calculated relative position of the relay apparatus with respect to the fixed apparatus and the calculated relative position of the positioning target apparatus with respect to the relay apparatus,
stores the calculated relative position of the relay apparatus with respect to the fixed apparatus, and
estimates, in a case where the stored relative position of the relay apparatus with respect to the fixed apparatus satisfies a prescribed condition, a position of the positioning target apparatus in the real space, on a basis of the calculated relative position of the positioning target apparatus with respect to the fixed apparatus.

2. The positioning system according to claim 1, wherein
the system
calculates a relative position of the positioning target apparatus with respect to the fixed apparatus by subtracting the calculated relative position of the relay apparatus with respect to the fixed apparatus from the calculated relative position of the positioning target apparatus with respect to the relay apparatus.

3. The positioning system according to claim 1, wherein
the system
calculates a variance of the stored relative positions of the relay apparatus with respect to the fixed apparatus, and
estimates, in a case where the calculated variance is equal to or less than a prescribed variance, a position of the positioning target apparatus in the real space, on a basis of the calculated relative position of the positioning target apparatus with respect to the fixed apparatus.

4. The positioning system according to claim 3, wherein
the system
calculates a relative position of the relay apparatus with respect to the fixed apparatus at a first timing on a basis of wireless communications between the fixed apparatus and the relay apparatus at the first timing,
calculates a relative position of the positioning target apparatus with respect to the relay apparatus at the first timing on a basis of wireless communications between the relay apparatus and the positioning target apparatus at the first timing,
calculates a relative position of the positioning target apparatus with respect to the fixed apparatus at the first timing on a basis of the calculated relative position of the relay apparatus with respect to the fixed apparatus at the first timing and the calculated relative position of the positioning target apparatus with respect to the relay apparatus at the first timing,
stores information regarding the calculated relative position of the relay apparatus with respect to the fixed apparatus at the first timing, and
calculates a variance of relative positions of the relay apparatus with respect to the fixed apparatus stored during a sampling period from the first timing to a second timing that is earlier than the first timing, and
estimates, in a case where the calculated variance is equal to or less than a variance of relative positions of the relay apparatus with respect to the fixed apparatus during a period longer than the sampling period, a position of the positioning target apparatus in the real space, on a basis of the calculated relative position of the positioning target apparatus with respect to the fixed apparatus at the first timing.

5. The positioning system according to claim 1, comprising:
the fixed apparatus.

6. The positioning system according to claim 1, comprising:
the positioning target apparatus.

7. The positioning system according to claim 1, comprising:
the relay apparatus.

8. The positioning system according to claim 1, comprising:
a plurality of the relay apparatuses disposed in prescribed positions away from the fixed apparatus, wherein
the system
selects one relay apparatus from among the plurality of relay apparatuses on a basis of the estimated position of the positioning target apparatus in the real space at a first timing,
calculates a relative position of the selected one relay apparatus with respect to the fixed apparatus at a second timing that is later than the first timing on a basis of wireless communications between the fixed apparatus and the one relay apparatus,
calculates a relative position of the positioning target apparatus with respect to the selected one relay apparatus at the second timing on a basis of wireless communications between the one relay apparatus and the positioning target apparatus,
calculates a relative position of the positioning target apparatus with respect to the fixed apparatus at the second timing on a basis of the calculated relative position of the one relay apparatus with respect to the fixed apparatus at the second timing and the calculated relative position of the positioning target apparatus with respect to the one relay apparatus at the second timing,
stores information regarding the calculated relative position of the relay apparatus with respect to the fixed apparatus at the second timing, and
estimates, in a case where the stored relative position of the one relay apparatus with respect to the fixed apparatus satisfies a prescribed condition, a position of the positioning target apparatus in the real space, on a basis of the calculated relative position of the positioning target apparatus with respect to the fixed apparatus at the second timing.

9. A relay apparatus that is disposed in a prescribed position away from a fixed apparatus disposed in a prescribed position in real space, wherein
the relay apparatus configured to:
calculate, on a basis of wireless communications with a positioning target apparatus capable of being carried by a mobile body, a relative position of the positioning target apparatus with respect to the relay apparatus, and
transmit the calculated relative position of the positioning target apparatus with respect to the relay apparatus to the fixed apparatus.

10. A positioning method comprising, at a positioning system to estimate a position of a positioning target apparatus capable of being carried by a mobile body:
calculating, on a basis of wireless communications between a fixed apparatus disposed in a prescribed position in real space and a relay apparatus disposed in a prescribed position away from the fixed apparatus, a relative position of the relay apparatus with respect to the fixed apparatus;
calculating a relative position of the positioning target apparatus with respect to the relay apparatus on a basis of wireless communications between the relay apparatus and the positioning target apparatus;
calculating a relative position of the positioning target apparatus with respect to the fixed apparatus on a basis of the calculated relative position of the relay apparatus with respect to the fixed apparatus and the calculated relative position of the positioning target apparatus with respect to the relay apparatus;
storing the calculated relative position of the relay apparatus with respect to the fixed apparatus; and
estimating, in a case where the stored relative position of the relay apparatus with respect to the fixed apparatus satisfies a prescribed condition, a position of the positioning target apparatus in the real space, on a basis of the calculated relative position of the positioning target apparatus with respect to the fixed apparatus.
